(19) United States
(12) Patent Application Publication
(10) Pub. No.: US 2010/0083864 A1
(43) Pub. Date: Apr. 8, 2010

(54) Pneutrain pneumatic mass transportation system

(76) Inventor: Patrick Joseph Flynn, Pinckney, MI (US)

Correspondence Address: Patrick J. Flynn, 3981 Swarthout Rd., Pinckney, MI, 48169, US

(21) Appl. No.: 12/587,066

(22) Filed: Oct. 1, 2009

Related U.S. Application Data
(60) Provisional application No. 61/195,509, filed on Oct. 8, 2008.

(51) Int. Cl. B65G 51/04; B61B 13/10; B65G 51/00

(52) U.S. Cl. 104/138.1

(57) ABSTRACT

This invention is a pneumatic mass transportation system on the cutting edge of technology employing a combined cycle turbine power system with digital controls to effect acceleration, deceleration and train propulsion. The combustion turbines can be adapted to use alternative fuels including bio fuels as they are developed. The heat recover steam generator will recycle the hot exhaust gasses from the turbines to generate electricity to be used by the system. The multi-car train is propelled by differential air pressure forward and aft of the vehicle in the pneumatic tube. Air propulsion is achieved by large in-tube impellers driven by the turbines. A digital control system will operate the pitch of the impeller blades and the vacuum/pressure release valves in the tubes to produce full movement control of the trains.

### REFERENCE TO RELATED APPLICATIONS

This invention claims priority to U.S. Provisional Patent Application No. 61/195,509 of the same title and filed Oct. 8, 2008, the entirety of which is hereby incorporated by reference.

### FEDERALLY SPONSORED RESEARCH OR DEVELOPMENT

Not applicable.

### REFERENCE TO SEQUENCE LISTING

Not applicable.

### BACKGROUND

1. Field of Invention

The need is imperative to develop new forms of safe, alternative transportation that are supremely energy efficient. This invention represents a unique approach to pneumatic ground transportation for passengers and cargo. The system's power source, method of propulsion and controls are exclusive elements to this invention.

2. Description of Prior Art

Pneumatic passenger systems have been conceived to date. They are burdened with un-resolved issues inherent in pneumatic systems intended for use other than the transport of inanimate objects. Power sources and control of movement of prior art have been problematic and present serious hindrances to practical development. Other system concepts are plagued with friction-related drawbacks due to car travel on slides and tracks within the tube. Pneumatic transportation of live passengers was developed into a prototype stage by Alfred Ely Beach in New York City in 1870. The use of a primitive power source (steam engine), the wooden tube, leather seals and lack of any practical movement control plagued the invention. The simultaneous development of the electric subway train then eclipsed all feasibility of Beach's efforts. The PneuTrain system detailed herein addresses and satisfies all drawbacks of prior art and incorporates new computer-based technology to solve the most critical of issues the starting, stopping, acceleration and deceleration of the system in cooperation of its very robust power source.

### SUMMARY OF THE INVENTION

The PneuTrain is a unique supremely efficient rapid pneumatic mass transportation system. This system incorporates a free moving train of passenger cars through a tube infrastructure powered by a combination of differential air pressure forward and aft of the train. The train cars will be cylindrical. They will contact the tube surface via guide wheels. Air power for the system will be provided by stationary combustion turbines and heat recovery steam generators at both ends of the pneumatic circuit. Combustion turbines can be adapted to alternative fuels including bio-fuels and fuel cell technology as they are explored and implemented. The integration of heat recovery steam generation recycles the very hot turbine exhaust to generate the electrical power needed for the system's controls. Air propulsion is generated through the use of large impellers in the tubes driven by the turbines. Speed control, acceleration and deceleration are all digitally controlled by the conductor. The digital controls and will vary the pitch of the impeller blades and control the operation of the pressure release valves imbedded into the tube walls.

### BRIEF DESCRIPTIONS OF THE ILLUSTRATIONS

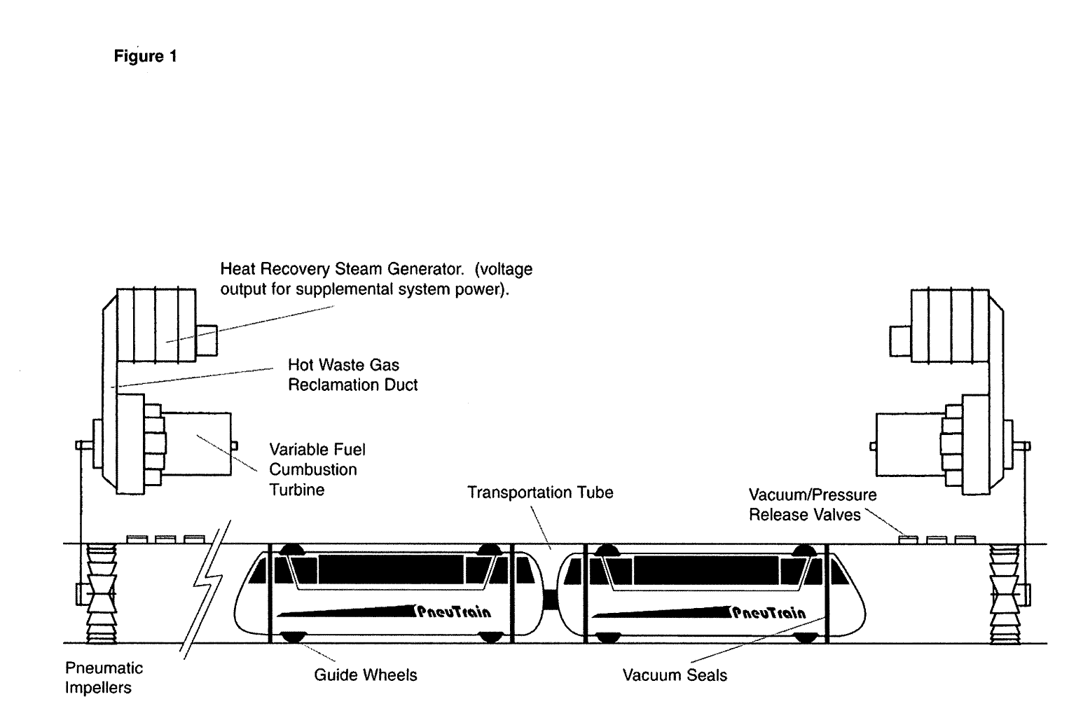

FIG. 1: Overall system configuration overview depicting vehicle, tube infrastructure, power source and control features.

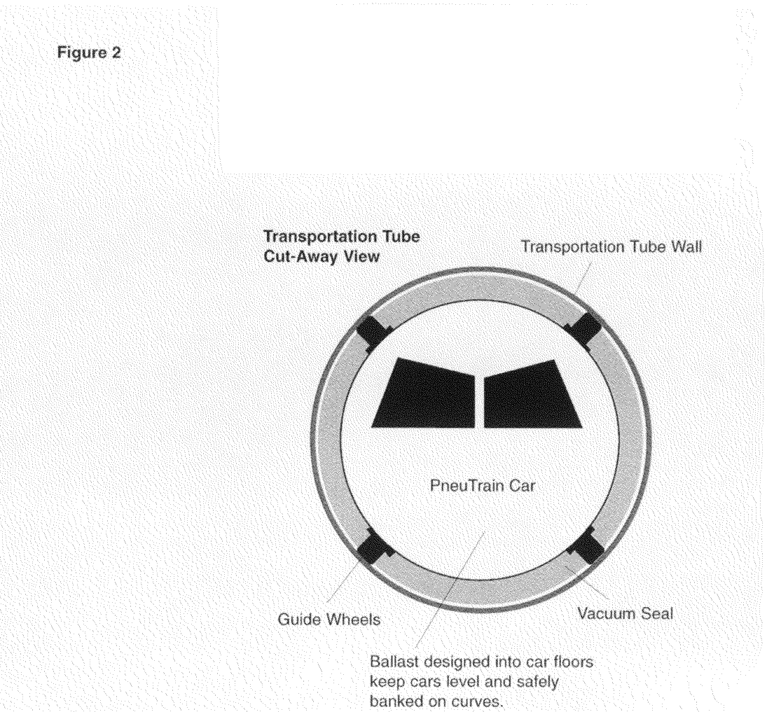

FIG. 2: Transportation tube sectional cutaway view depicting front of vehicle, vacuum seal, guide wheels and ballast.

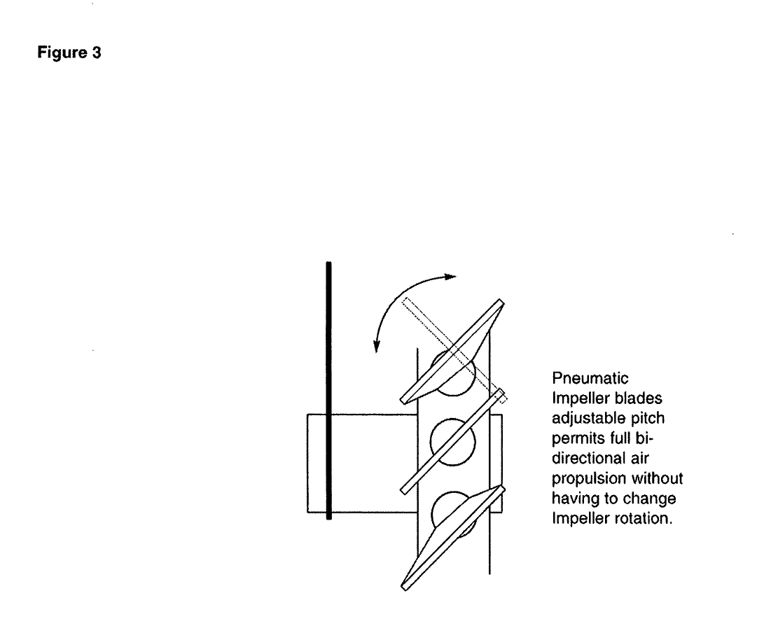

FIG. 3: Exploded view of exclusive impeller blade pitch control.

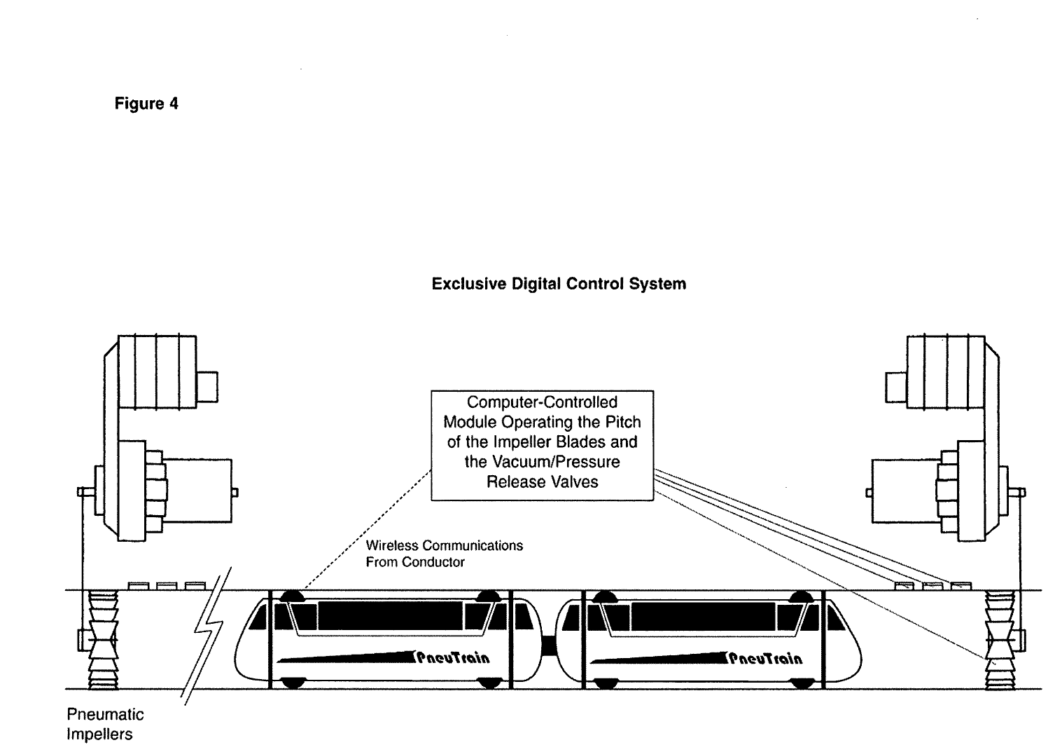

FIG. 4: Overall system configuration depicting exclusive digital control operations of vehicle movement.

### DETAILED DESCRIPTION OF THE INVENTION

The PneuTrain system in concept utilizes as its power source the proven and extremely efficient combination of combustion turbine technology married to a heat/exhaust recycling steam generator. This is exclusive to the PneuTrain.

Clean natural gas is currently the fuel of choice to power these turbines. Natural gas is very efficient. It is also abundant in supply right here in the United States. Additionally, the combustion turbine is a versatile power source to physically drive the pneumatic impellers of the PneuTrain system. High temperature exhaust from the turbine is recovered and utilized in a second stage to produce steam generated electricity. The technology is well underway driven by global need to convert combustion turbines to utilize alternative fuel sources including bio fuels as they are developed. Since the fuel source is employed at the turbine, the PneuTrain power system can be upgraded to use new fuels without having to upgrade, redesign or replace the PneuTrain cars or the transportation tube infrastructure.

The upper portion of the transportation tubes can be designed to be transparent for visual access in portions of the pneumatic circuit that are exposed above ground and through buildings.

The PneuTrain cars can be designed in the fashion of modern commuting subway cars providing seating on the sides and sufficient standing and maneuvering floor space.

### 8.1. Mechanical Detail

The PneuTrain cars in concept are cylindrical with vacuum seals around their circumference. Guide wheels (pneumatic tire wheels with suspension) keep the cars in place and provide smooth, consistent movement with minimum friction. Ballast designed into car floors will keep the cars level and safely banked on curves in proportion to the train speed. The cars are propelled through the tube utilizing differential air pressure forward and aft of the vehicle. The air propulsion is generated from the pneumatic impellers, which are driven by the turbines utilizing a chain drive system or a drive shaft (FIG. 1 depicts a chain drive system concept).

The pneumatic impellers exclusive to this design will be designed to fully adjust the pitch of their blades to be capable of effecting air propulsion in either direction on the fly without having to change impeller rotation or turbine speed. This makes the PneuTrain completely bi-directional in its travel capabilities.

PneuTrain car travel speed, acceleration, deceleration, starting and stopping will be controlled by computer management of the impeller blade pitch, turbine speed, and operation of the variable vacuum/pressure release valves built into the walls of the transportation tube. This software-based operation, exclusive to the PneuTrain would be under the control of the PneuTrain conductor. Manual overrides will be designed into the system for optimum control in the event of a pneumatic malfunction.

The PneuTrain cars will be equipped with battery-powered lighting and conditioned ventilation. A supplemental electrical motor will be on board that can be used to move the train completely independent of the pneumatic system in the event of pneumatic failure. The electrical power needed to recharge the batteries will be generated by the PneuTrain system's heat recovery steam generator. When PneuTrain cars are not in use, they will be connected to this recharging system to keep the batteries fully charged.

PneuTrain stations will employ the opening of sections in the tube to accommodate the loading and unloading of passengers.

### 8.2. Impact

The PneuTrain is transformational by its very nature. This will be the first highly technical pneumatic transport passenger system. Unlike aircraft that need their turbine exhaust for thrust, the turbines that power the PneuTrain system are stationary. This allows for full access to the turbines and the reclamation of the turbine's very hot exhaust for the purpose of generating the electric power needed for the system's lighting, ventilation, conditioning, and backup drive. The high efficiency and new alternative fuel potential make the PneuTrain a truly “green” concept. The development of the PneuTrain has the potential to put the United States at the cutting edge of modern mass transportation development.

The wide-scale implementation of the PneuTrain system will result in substantial reduction in energy use. As new fuels are developed domestically and retrofitted onto the system's turbines, we can see dramatic reductions in the imports of foreign energy resources.

The development of this invention opens wide the door for future development of the concept for long-distance, extremely high-speed usage.

### 8.3. Safety Considerations

No fuel is stored on board the PneuTrain cars and in proximity of the passengers eliminating the possibility of fuel related accidents.

No high voltage hazards are present in the tubes or in proximity of the passengers as in subways and electrical trains.

Collisions are impossible since the design of the PneuTrain would have only one multi-car train per pneumatic circuit.

As mentioned above, the PneuTrain Cars will have a supplemental electrical motor to be able to move the cars through the tubes in the unlikely event of a pneumatic failure. Also on board will be a supplemental oxygen supply in the event of an emergency. Additionally, the transportation tubes will be designed with quickly removable sections or panels at strategic locations between stations for evacuation purposes.

The PneuTrain system is meant to be completely self-powered. Unlike subway systems and surface electrical trains, operation of the PneuTrain would be unaffected by electrical outages as long as the fuel source remains intact at the turbines. This would provide safe efficient mass transportation at vital times during power failures.

Effective mass transportation enhances the quality of life of metropolitan areas both economically, and environmentally.

Home values, business values, and the marketability of communities rise dramatically in areas with good, reliable mass transportation.

Metro areas that develop cutting edge innovations in mass transportation, energy and vehicular traffic reductions attain national and global recognition.

The value-added appeal of the PneuTrain will be sought after by urban venues, theme parks, military bases, sports complexes, convention centers, airports and shopping malls. The system can be adapted for travel alongside bridges, through buildings and as under-water crossings.

### REFERENCES

¹ Biofuels in Gas Turbines, International Turbomachinery, Vol. 49, No. 7, December, 2008

I claim:

1. A variable-speed pneumatic transportation system comprising:
A system of tubular sections of specified length to form a designed travel circuit.
One multi-car vehicle operating as a free piston within the pneumatic tube travelling on guide wheels (pneumatic tires) with suspension.
A power system utilizing a variable-fuel combustion turbine and a heat recovery steam generator at each end of the pneumatic circuit.
A propulsion system utilizing turbine-driven pneumatic impellers (fans) with variable pitch blades at each end of the pneumatic circuit.
A digitally controlled speed/acceleration/deceleration system operating impeller blade pitch and pressure release valves in the tube infrastructure.

2. The variable-speed pneumatic transportation system as claimed in item 1 above, wherein the power source, unlike the aircraft turbine is stationary permitting full and constant access and usage of the turbine's extremely hot exhaust.

3. The variable-speed pneumatic transportation system as claimed in item 1 above, wherein a heat recovery steam generator, recycling the very hot waste gasses of the turbines generates electric power to be utilized for the system's controls, heating/cooling/ventilation, lighting and supplemental motors.

4. The variable-speed pneumatic transportation system as claimed in item 1 above, wherein the combustion turbines as the system's power source will be easily adaptable for alternative fuel usage including newly developed and future bio-fuels making the system extremely efficient and “green.”

5. The variable-speed pneumatic transportation system as claimed in item 1 above, wherein the system will have on board a supplemental electric motor to move the train to a station in the event of a pneumatic failure.

6. The variable-speed pneumatic transportation system as claimed in item 1 above, wherein the air propulsion will be affected by impellers driven by the turbines in the tube that incorporate adjustable blades.

7. The variable-speed pneumatic transportation system as claimed in item 1 above, wherein the fully adjustable pitch of the impeller blades will permit the turbines to run at a constant speed while controlling train direction and speed.

8. The variable-speed pneumatic transportation system as claimed in item 1 above, wherein vacuum and pressure release valves will be built into the tube infrastructure to aid impeller blade pitch in accelerating, decelerating, stopping and starting the train.

9. The variable-speed pneumatic transportation system as claimed in item 1 above, wherein a completely unique custom digital control system will be developed to operate the impeller blade pitch and release valves in conjunction with each other. These controls will be under the operation of the system conductor.

10. The variable-speed pneumatic transportation system as claimed in item 1 above, wherein completely effective bi-directional travel is designed into the system.

11. The variable-speed pneumatic transportation system as claimed in item 1 above, wherein the train cars of the system with ballast designed into the floor portion will bank safely on curves in the tube in direct relationship to their speed.

12. The variable-speed pneumatic transportation system as claimed in item 1 above, wherein the upper portion of the tube infrastructure can be transparent where most advantageous.

13. The variable-speed pneumatic transportation system as claimed in item 1 above, wherein sections of the tube infrastructure can be easily and quickly removed externally for purposes of evacuation.

14. The variable-speed pneumatic transportation system as claimed in item 1 above, wherein stations for loading and unloading of passengers and cargo will be designed into the pneumatic circuit.

15. The variable-speed pneumatic transportation system as claimed in item 1 above, wherein the system, due to its complete enclosure will be unaffected by weather and other environmental conditions.

16. The variable-speed pneumatic transportation system as claimed in item 1 above, wherein the system will remain completely operational independent of external power interruptions assuming the fuel source is sustained.
